(19) United States
(12) Patent Application Publication
(10) Pub. No.: US 2024/0185200 A1
(43) Pub. Date: Jun. 6, 2024

(54) MANAGEMENT OF USER USAGE INFORMATION ASSOCIATED WITH AN APPLICATION PROGRAMMING INTERFACE PROVIDER

(71) Applicant: Moesif, Inc., San Francisco, CA (US)

(72) Inventors: Derric Stephen Gilling, San Francisco, CA (US); Xingheng Timothy Wang, San Francisco, CA (US); Akash A. Nankani, Fremont, CA (US)

(21) Appl. No.: 18/061,321

(22) Filed: Dec. 2, 2022

(51) Int. Cl. G06Q 20/14

(52) U.S. Cl. CPC G06Q 20/145

(57) ABSTRACT

Systems, methods, and software described herein manages the allocation of values to application programming interface (API) requests by an end user. In one example, a monitoring service can determine at least one usage value associated with a user of an API provider based on conditional statements for the user and API usage information associated with the user. The monitoring service can further format the at least one usage value for the user based on a billing service for the user and communicate the at least one usage value to the billing service.

### BACKGROUND

Web service application programming interfaces (APIs) are defined interfaces that permit interactions to occur between the service associated with the APIs and users of the APIs. These APIs may permit users to obtain data from the service associated with the API, post data to the service associated with the API, or provide some other data operation with relation to the service associated with the API. For example, a web service API may permit an eCommerce seller to obtain shipping information, such as cost estimates, from a shipping service provider. Thus, rather than locally importing and updating the information from the shipping service provider, the eCommerce seller may obtain the required information from one or more databases maintained by the shipping service provider.

However, although APIs may provide efficient access to data between different services, difficulties can occur in determining how the various end users interact with and use the APIs. For example, a first user can use an API provider at a first rate, while a second API provider uses API provider at a second rate. Additionally, difficulties can arise in monitoring the usage associated with the API provider and summarizing the usage and costs for the different users.

### Overview

Provided herein are systems, methods, and software to manage usage information associated with users of an application programming interface (API) provider. In at least one implementation, a monitoring service for an API provider obtains configuration information for generating usage values associated with API requests to the API provider by a user. The monitoring service further obtains API request information associated with API requests by the user to the API provider and determines at least one usage value associated with the user based on the API request information and the configuration information. After determining the at least one usage value, the monitoring service further identifies a billing service from a plurality of billing services associated with the user, formats the at least one value based on the billing service, and communicates the at least one formatted usage value to the billing service.

In at least one implementation, the monitoring service can further determine when the at least one usage value for the user satisfies one or more criteria and can generate a notification based the usage criteria. The notification can be used to change the configuration information associated with the user and the conditional statements that increase the at least one value associated with the user.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to maintain usage information associated with users of an application programming interface (API) provider according to an implementation.

FIG. 2 illustrates an operation of a monitoring service to manage usage information associated with a user of an API provider according to an implementation.

FIG. 3 illustrates a data structure to manage a configuration for usage values associated with an API provider according to an implementation.

FIG. 4 illustrates an operational scenario of formatting and communicating usage values associated with a user according to an implementation.

FIG. 5 illustrates an operational scenario of updating configuration information associated with generating usage values for users of an API provider according to an implementation.

FIG. 6 illustrates a computing system to manage usage information associated with a user of an API provider according to an implementation.

### DETAILED DESCRIPTION

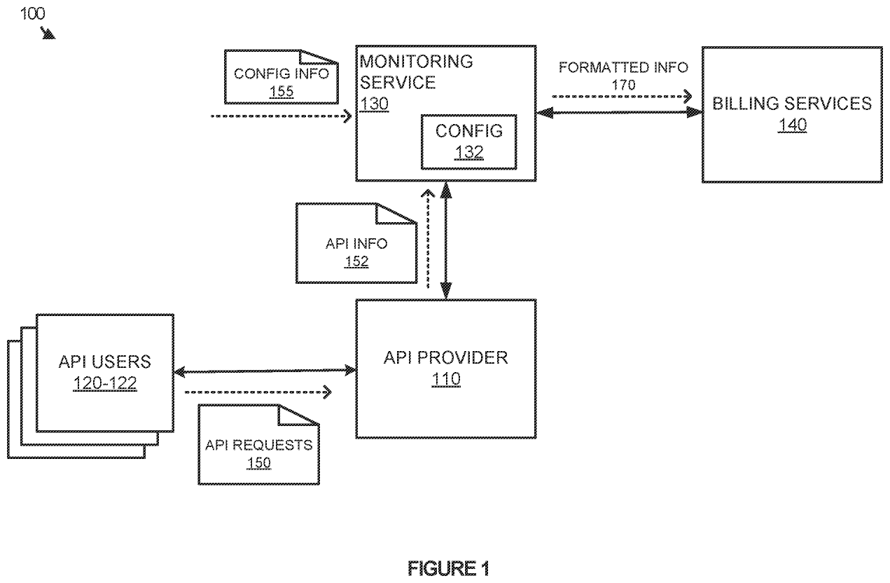

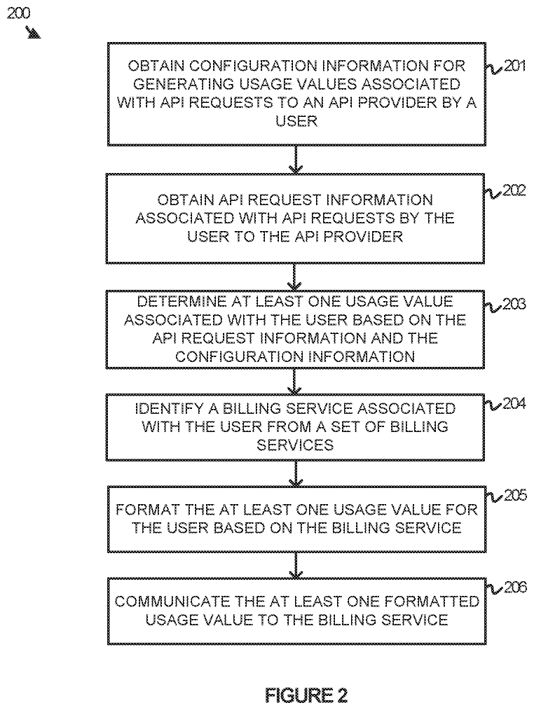

FIG. 1 illustrates a computing environment to maintain usage information associated with users of an application programming interface (API) provider according to an implementation. Computing environment 100 includes API users 120-122, API provider 110, monitoring service 130, and billing services 140. Computing environment 100 further includes API requests 150 from API users 120-122, API request information 152, configuration information 155, and formatted information 170. Monitoring service 130 can perform operation 200 further described below with respect to FIG. 2 and includes configuration 132.

In operation, API users 120-122 generate API requests 150 over a network connection to API provider 110, wherein the requests may be used to provide various functionality for the API users. API requests 150 may correspond to requests to retrieve information from a service provided by API provider 110, post information to a service provided by API provider 110, modify data stored by a service provided by API provider 110, or some other operation associated with API provider 110. As an example, an API request of API requests 150 may request a social media post corresponding to a user of a social media service provided by API provider 110. API users 120-122 may correspond to individual users, service providers, such as other web services (video, social media, and the like), or some other user of a web API. API provider 110 may comprise a social media API provider, a mail service API provider, a video service API provider, or some other API provider.

As API requests 150 are obtained by API provider 110, API request information 152 is provided to monitoring service 130. API request information 152 can indicate the user associated with the request, the type of API request for each of the requests, the timestamp associated with the requests, an indication of whether the request was successful, the amount of data communicated in response to the request, or some other information associated with the API requests from API users 120-122. In addition to obtaining the API request information 152, monitoring service 130 further obtains configuration information 155 that is used for configuration 132. The configuration information 155 can provide one or more conditional statements that are used to update one or more usage values associated with an API user of API users 120-122, wherein the usage values can comprise monetary values or some other usage metric associated with API provider 110. The conditional statements may each indicate one or more criteria to increase a usage value associated with an API user. For example, a conditional statement in configuration information 155 for API user 120 may indicate that for every ten successful API requests to API provider 110, then a usage value for the user is increased by one.

As the one or more usage values are identified in association with each API user of API users 120-122, monitoring service 130 communicates formatted information 170 to an appropriate billing service of billing services, wherein the formatted information indicates the usage values associated with the corresponding user. For example, monitoring service 130 can obtain API request information 152 for API user 120. Monitoring service 130 can apply configuration 132 to the API request information 152 to determine a usage value associated with API user 120. Once usage value is determined, wherein the usage value may comprise a monetary value in some examples, the usage value is communicated to a billing service. In communicating the usage value, monitoring service 130 can format the usage value along with other user identifier information to the billing service, wherein formatting the usage value can comprise placing the usage value within a file format and communicating the formatted value using credentials associated with the user.

FIG. 2 illustrates an operation 200 of a monitoring service to manage usage information associated with a user of an API provider according to an implementation. The steps of operation 200 are referenced parenthetically in the paragraphs that follow with reference to systems and elements of computing environment 100 of FIG. 1.

For operation 200, monitoring service 130 obtains (201) configuration information for generating usage values associated with API requests to an API provider by a user. The configuration information may comprise one or more conditional statements that trigger an increase to one or more usage values associated the user. For example, a conditional statement can increase the usage value by one after five API requests are received with a particular API function and the response to the request was successful. When requests do not include the API function or the response is not successful to the API request, then a request will not qualify for the conditional statement. While this is one example of a conditional statement, users can be associated with any number of conditional statements. In at least one example, the conditional statements associated with a user may correspond to a service agreement for the user, wherein the user can select how the one or more values are increased for the user. Thus, while API user 120 can use first configuration information and first conditional statements, API user 121 can use second configuration information and second conditional statements.

Operation 200 further obtains (202) API request information associated with API requests by the user to the API provider. The API request information can indicate the user associated with the requests from API users 120-122, can indicate a time stamp associated with the request, an API function associated with the request, an amount of data communicated in association with the request, or some other information associated with the API requests from the user. Operation 200 then determines (203) at least one usage value associated with the user based on the API request information and the configuration information. In at least one example, monitoring service 130 can apply the conditional statements represented in configuration 132 associated with the user to determine how to increment a usage value for a user. The conditional statements can increment the one or more values, or a monetary cost for the user, based on the type of API function used in the requests, the frequency of the API function used, the amount of data communicated in relation to the API function, or some other factor in association with an API request, including combinations thereof. The at least one usage value can be calculated during a period (e.g., week, month, etc.), wherein API request information 152 can be supplied at the request of monitoring service 130, can be supplied at periodic intervals, or can be provided at some other interval. Monitoring service 130 can maintain the at least one value and update the value as the information is obtained from API provider 110.

In addition to determining the at least one usage value, operation 200 also identifies (204) a billing service from a plurality of billing services that is associated with the user and formats (205) the at least one usage value based on the billing service. Once formatted, operation 200 communicates (206) the at least one formatted usage value to the billing service. In some examples, API users 120-122 can use a variety of different billing services 140 that require different formats, security requirements, and the like. Accordingly, monitoring service 130 may format the at least one value associated with an API user of API users 120-122 in accordance with the requirements for the billing service, wherein formatting can include placing the value in a file format required for the billing service. Additionally, monitoring service 130 can use security information provided at least partially from configuration information 155 to communicate with the billing service. The security information can include user identifiers, encryption requirements, or some other security information to interact with the billing service.

In at least one example, monitoring service 130 can maintain the usage values for the API users 120-122 in a common data structure of a first format. When the values are required to be communicated to a billing service of billing services 140, the one or more values associated with the user can be formatted for the billing service and communicated to the billing service.

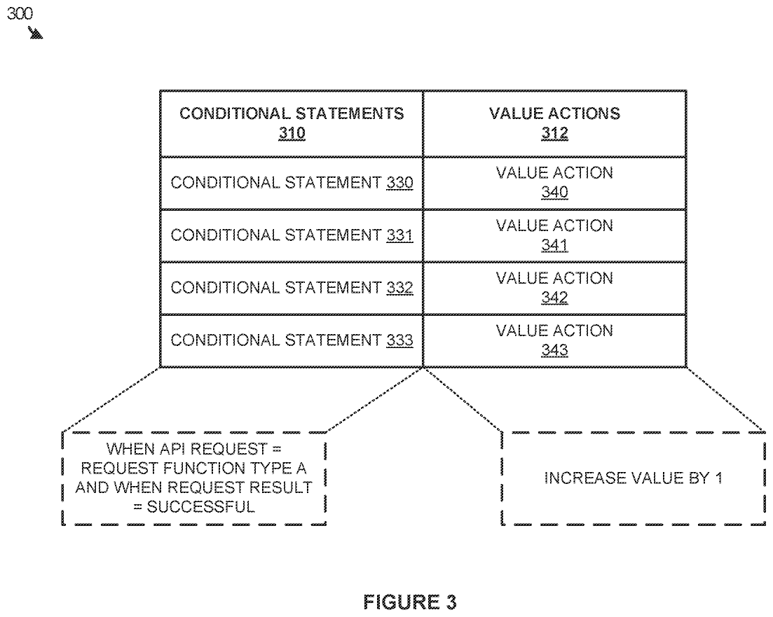

FIG. 3 illustrates a data structure 300 to manage a configuration for usage values associated with an API provider according to an implementation. Data structure 300 is representative of the configuration information that is used to determine the one or more usage values associated with a user of an API provider. Data structure 300 includes conditional statements 310 with conditional statements 330-333 and value action 312 with value actions 340-343. Although demonstrated as a table, the configuration information can be stored in any other data structure capable of applying conditional statements to API request information associated with an API provider.

In a computing environment, a user of an API provider is allocated configuration information or rules that are used to measure the usage of the API provider by the user. The API configuration includes conditional statements 310 that are used to increase at least one usage value associated with the user. The conditional statements, such as the example for conditional statement 333, can determine whether the API request information associated with API requests from the user satisfy one or more criteria to increase a usage value. In the example of conditional statement 333, the usage value is increase by one (value action 343) when the API request comprises a function type of function type A and when the request result is classified as successful. If the request information associated with an API request does not satisfy the criteria, then value action 343 will not be applied, however, another conditional statement of conditional statements 330-332 may apply to the API request and update a value.

Although conditional statement 333 uses the function type and the result of the API request, other request information can be used in conjunction with the conditional requirements for increasing the one or more usage values associated with a user. The other request information can include the frequency that the API requests occurred, the amount of data associated with responding to the request, the timestamp of the request (i.e., when the request occurred), or some other information associated with the API requests to the API provider. As an additional example of a conditional expression, a value will only be increased when a threshold amount of data is returned in response to one or more API requests. Thus, the quantity of data to support multiple requests can satisfy criteria to increase a usage value for the user. Further, while demonstrated as increasing the value by one, the value can be increased by any value when the criteria are satisfied. For example, in a tiered service, the value can be increased by a quantity defined with the tier. Thus, the usage value can be increased to a first value when a first quantity of API requests is generated by the user and can be increased to a second value when a second quantity of API requests is generated by the user.

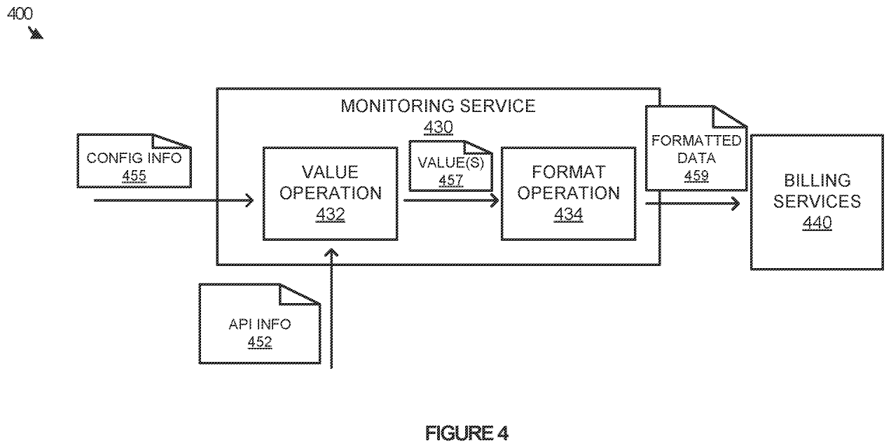

FIG. 4 illustrates an operational scenario 400 of formatting and communicating usage values associated with a user according to an implementation. Operational scenario 400 includes billing services 440 and monitoring service 430 that receives configuration information 455 and API request information 452. Operational scenario 400 further includes value(s) 457 and formatted data 459. Monitoring service 430 further includes value operation 432 and format operation 434.

In operational scenario 400, value operation 432 is performed by monitoring service 430 based on configuration information 455 and API request information 452. Configuration information 433 can comprise at least conditional statements that are used to increase usage values associated with a user, wherein the usage values may comprise monetary values in some examples but can comprise any value used by a billing service to generate a bill for a user of the API provider. The conditional statements can increase the one or more usage values based on the type of API requests generated by a user, a determination of whether the request was successful (e.g., header information indicating the success of the communication), the amount of data communicated, or some other information from the API requests. As an example, a conditional statement may increase the usage value by 5 when a request is generated with a first type of API and the request indicates a successful return of a value.

Here, from configuration information 455 supplied to monitoring service 430, monitoring service 430 performs value operation 432 using API information 452 and configuration information 455. API information 452 can indicate the types of API requests generated by a user to an API provider, the quantity that each of the types are requested, success information associated with the API requests, the timestamps of the API requests, the amount of data communicated in association with the API request, or some other API request information associated with a user request to an API provider. The information is then applied by value operation 432 to the conditional statements in configuration information 455 to determine value(s) 457. As an example, a first set of requests can increase a value when the requests comprise 5 examples of a successful API request of a first type. In contrast, a second set of requests can cause not change in a value when the requests do not indicate that a successful response was given to the request. Configuration information 455 can include any number of statements that can be applied to increase one or more values for the user. In some examples, a user can use an aggregated value that applies to all the API request information. In other examples, the values can be separated based on the types of API requests, the time of the API requests, or some other factor. For example, a first value can represent the API usage by the user during a first period, while a second value can represent the API usage by the user during a second period.

After value(s) 457 are determined, monitoring service 430 provides format operation 434 that is used to format value(s) 457 in accordance with the billing service for the user. In some implementations, the values for the users of the API provider can be stored in a first format or first data structure. Each of the users can be associated with a billing service of a plurality of billing services that is used to aggregate billing information from different service providers, such as cloud computing, software licensing, and the like. Based on the billing service for the user, format operation 434 can transform or format value(s) 457 into a file that is acceptable to the billing service of billing services 440. The user can provide monitoring service 430 with an identifier for the billing service, identifier information for the user, security information for the user, or some other information from the user. From the information, format operation 434 can generated formatted data 459 that can be provided to the required billing service. Formatted data 459 can be sent periodically for the user, can be sent based on a request from the billing service, can be sent when the one or more values satisfy criteria for communication or can be sent at some other interval. As an example, monitoring service 430 can communicate one or more values to a billing service at weekly intervals representative of the API usage by the user during the corresponding week.

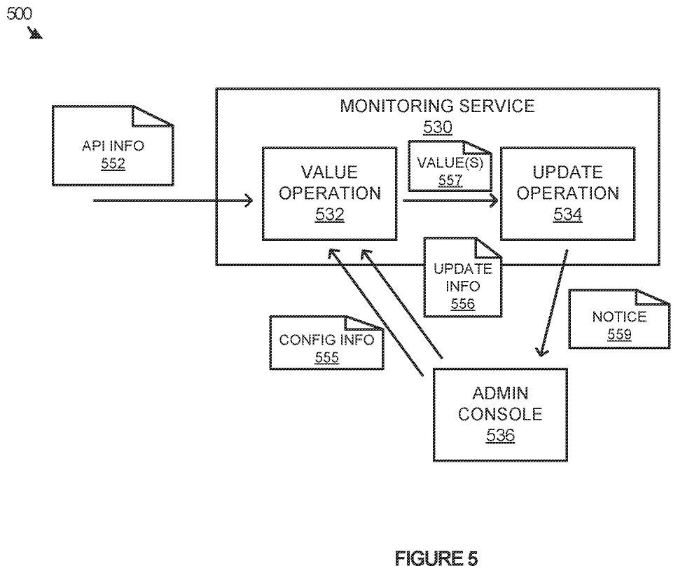

FIG. 5 illustrates an operational scenario 500 of updating configuration information associated with generating usage values for users of an API provider according to an implementation. Operational scenario 500 includes monitoring service 530 that further includes value operation 532 and update operation 534. Operational scenario 500 further includes APIR request information 552, configuration information 555, update information 556, value(s) 557, notice 559, and administrator console 536.

As described herein, monitoring service 530 obtains API request information 552 associated with a user's use of an API provider. The user may comprise an organization of devices and people or an individual person or device. The API request information can identify the types of API requests, the timestamps associated with the API requests, an indication of whether the request was successful, a quantity of data communicated for the API request, or some other API request information. In addition to receiving the API request information 552, an administrator console 536 can provide configuration information 555 that defines conditional statements for generating one or more usage values for the user. The conditional statements can include one or more criteria from API request information 552 to trigger an increase in the usage value(s) 557. The criteria can include a quantity of API requests of a type, a quantity of successful requests, an amount of data returned for the API requests, or some other criteria from the requests, including combinations thereof.

Here, as usage value(s) 557 are generated from API request information and configuration information 555, monitoring service 530 employs update operation 534 to determine whether the value(s) satisfy one or more criteria to suggest a modification to the configuration information. The suggestion can be used to reduce the value(s) during future periods for the user. In at least one example, update operation 534 can determine whether value(s) 557 exceed a threshold to change a configuration from a first configuration to a second configuration. The first configuration can bill based on the quantity of requests, while the second configuration can support a constant (or flat rate) value for the user. Advantageously, during a first period it may be better for the user to increase values based on use of the API, while during a second period it may be better for the user to have a constant or flat value for the API use.

When value(s) 557 satisfy one or more criteria to suggest a modification to the configuration information, update operation 534 generates a notification (notice 559) to an administrator console 536, wherein the console is representative of a management device for a user (i.e., could be a device using the API provider). The notification can indicate information about the current configuration, can include information about the potential modifications to the configuration, can indicate current usage values and potential changes to the usage values with the new configuration, or can provide some other information in association with the modification. Once provided, a user at administrator console can approve the modification or deny the modification. If approved, configuration information 555 is applied and provided to value operation 532 for future processing of the API request information from the API provider. The process can then be repeated with the new configuration to determine whether any additional modifications should be made to the configuration.

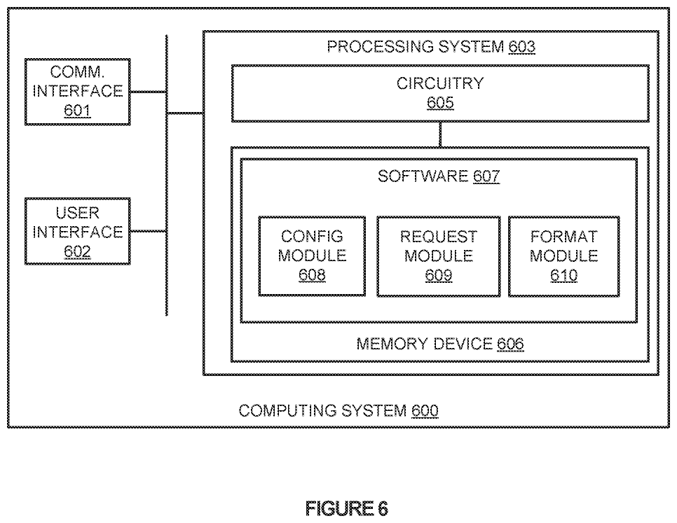

FIG. 6 illustrates a computing system 600 to manage usage information associated with a user of an API provider according to an implementation. Computing system 600 is representative of any computing system or systems with which the various operational architectures, processes, scenarios, and sequences disclosed herein for a monitoring service may be implemented. Computing system 600 is an example monitoring service 130, although other examples may exist. Computing system 600 comprises communication interface 601, user interface 602, and processing system 603. Processing system 603 is linked to communication interface 601 and user interface 602. Processing system 603 includes processing circuitry 605 and memory device 606 that stores operating software 607. Computing system 600 may include other well-known components such as a battery and enclosure that are not shown for clarity.

Communication interface 601 comprises components that communicate over communication links, such as network cards, ports, radio frequency (RF), processing circuitry and software, or some other communication devices. Communication interface 601 may be configured to communicate over metallic, wireless, or optical links. Communication interface 601 may be configured to use Time Division Multiplex (TDM), Internet Protocol (IP), Ethernet, optical networking, wireless protocols, communication signaling, or some other communication format—including combinations thereof. In at least one implementation, communication interface 601 may be used to communicate with one or more computing systems that act as an API provider that receives API requests from API users. Communication interface 601 may further communicate with one or more console devices that correspond to administrators associated with the API provider. The console devices may comprise smartphones, tablets, computers, or some other console device. Communication interface 601 may further communicate with computing systems that support billing services for users of the API provider.

User interface 602 comprises components that interact with a user to receive user inputs and to present media and/or information. User interface 602 may include a speaker, microphone, buttons, lights, display screen, touch screen, touch pad, scroll wheel, communication port, or some other user input/output apparatus—including combinations thereof. User interface 602 may be omitted in some examples.

Processing circuitry 605 comprises microprocessor and other circuitry that retrieves and executes operating software 607 from memory device 606. Memory device 606 may include volatile and nonvolatile, removable, and non-removable media implemented in any method or technology for storage of information, such as computer readable instructions, data structures, program modules, or other data. Memory device 606 may be implemented as a single storage device but may also be implemented across multiple storage devices or sub-systems. Memory device 606 may comprise additional elements, such as a controller to read operating software 607. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing circuitry 605 is typically mounted on a circuit board that may also hold memory device 606 and portions of communication interface 601 and user interface 602. Operating software 607 comprises computer programs, firmware, or some other form of machine-readable program instructions. Operating software 607 includes configuration module 608, request module 609, and format module 610, although any number of software modules may provide a similar operation. Operating software 607 may further include an operating system, utilities, drivers, network interfaces, applications, or some other type of software. When executed by processing circuitry 605, operating software 607 directs processing system 603 to operate computing system 600 as described herein. Software 607 can direct processing system 603 to provide at least the operations of a monitoring service as described herein from FIGS. 1-5.

In one implementation, configuration module 608 directs processing system 603 to obtain configuration information for generating usage values associated with API requests to an API provider by a user. Request module 609 further directs processing system 603 to obtain API request information associated with API requests by the user to the API provider and determine at least one usage value associated with the user based on the API request information and the configuration information. In some examples, the configuration information comprises conditional statements that are used to increase, decrease, or otherwise update the usage values associated with the user. The configuration information can be applied to the API request information to update at least one usage value associated with the user, wherein the usage value can comprise a cost associated with the usage by the user. As an example, a conditional statement can increase a usage value for a user for every 5 completed or successful API requests of a first type. In another example, an API request can be ignored or not be used to increase the usage values when the API requests fail to indicate that the request was successful.

After the one or more usage values are determined for the user, format module 610 directs processing system 603 to identify a billing service from a plurality of billing services associated with the user, format the at least one usage value based on the billing service, and the at least one formatted usage value to the billing service. In some implementations, the different users of an API provider can be associated with a billing service of a plurality of billing services, wherein each of the services can require a particular format. The format can comprise a file format, communication format, or some other format associated with the billing service. In some examples, each user can indicate the billing service that is used, and credentials associated with the user for the billing service, such that format module 610 can format the one or more values for the user and submit the one or more values to the billing service. The formatted values can be supplied periodically, when at least one value satisfies a threshold, or at some other interval.

In some examples, configuration module 608 directs processing system 603 to determine when the one or more values for the user satisfy criteria to update the configuration (i.e., the conditional statements that update the one or more values for a user). In at least one implementation, an API provider can include different tiers associated with generating values for end users. For example, a first configuration can generate one or more values using a first set of conditional statements, while a second configuration can generate one or more values usage a second set of conditional statements. Depending on the use case for the API user, the user can select a first configuration, wherein the configuration can generate values based on the types of API requests, the quantity of API requests, the amount of data returned, or some other factor. When one or more values for the user satisfy criteria, configuration module 608 can identify that the user can use an alternative configuration, which could permit reduced values (i.e., cost for the user). For example, a first configuration can increase a value for a user for every API request, which can be beneficial for a user that limits the use of the API provider. However, as the use of the API provider increases, it can be beneficial for the user to switch to a flat rate configuration that maintains a single value and does not increase the value based on each API request from the user.

In identifying a modification to the configuration, configuration module 608 can generate a notification that is supplied to an administrator console or user device associated with a user. The notification can indicate information about the current configuration, information about the changes that could be made to the current configuration, and the resultant changes in values from the modification to the configuration. A user can then select to accept the modification or decline the modification. If accepted, a response is provided to update the configuration using configuration module 608. In other examples, rather than providing a notification to the user, configuration module 608 can automatically update the configuration to reduce the one or more usage values associated with the user.

Returning to the elements of FIG. 1, API users 120-122, API provider 110, billing services 140, and monitoring service 130 may each comprise communication interfaces, network interfaces, processing systems, computer systems, microprocessors, storage systems, storage media, or some other processing devices or software systems and can be distributed among multiple devices. Examples of API users 120-122, API provider 110, billing services 140, and monitoring service 130 can include software such as an operating system, logs, databases, utilities, drivers, networking software, and other software stored on a computer-readable medium. API users 120-122, API provider 110, billing services 140, and monitoring service 130 may comprise, in some examples, one or more server computing systems, desktop computing systems, laptop computing systems, or any other computing system, including combinations thereof.

Communication between API users 120-122, API provider 110, billing services 140, and monitoring service 130 may use metal, glass, optical, air, space, or some other material as the transport media. Communication between API users 120-122, API provider 110, billing services 140, and monitoring service 130 may use various communication protocols, such as Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format, including combinations, improvements, or variations thereof. Communication between API users 120-122, API provider 110, billing services 140, and monitoring service 130 may be a direct link or can include intermediate networks, systems, or devices, and can include a logical network link transported over multiple physical links.

The included descriptions and figures depict specific implementations to teach those skilled in the art how to make and use the best option. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
obtaining configuration information for generating usage values associated with application programming interface (API) requests to an API provider by a user;
obtaining API request information associated with API requests by the user to the API provider;
determining at least one usage value associated with the user based on the API request information and the configuration information;
identifying a billing service from a plurality of billing services associated with the user;
formatting the at least one usage value based on the billing service; and
communicating the at least one formatted usage value to the billing service.

2. The method of claim 1, wherein the configuration information comprises one or more conditional statements that trigger an increase to a usage value of the at least one usage value when one or more criteria are satisfied.

3. The method of claim 1, wherein the API request information comprises an identifier for each DNS request of the API requests.

4. The method of claim 3, wherein the API request information further comprises a success indication associated with each DNS request of the API requests, or a data size associated with a response to each API request of the API requests.

5. The method of claim 1, wherein formatting the at least one usage value based on the billing service comprises formatting the at least one usage value into a file format associated with the billing service.

6. The method of claim 1 further comprising:
determining whether the at least one usage value for the user satisfies one or more criteria to suggest a modification to the configuration information;
generating a notification for the user indicating the modification.

7. The method of claim 6, wherein the notification indicates one or more conditional statement modifications to the configuration information and one or more potential value changes to the at least one usage value from the one or more conditional statement modifications.

8. The method of claim 1, wherein the at least one usage value comprises a monetary value.

9. A computing apparatus comprising:
a storage system;
a processing system operatively coupled to the storage system; and
program instructions stored on the storage system that, when executed by the processing system, direct the computing apparatus to:
obtain configuration information for generating usage values associated with application programming interface (API) requests to an API provider by a user;
obtain API request information associated with API requests by the user to the API provider;
determine at least one usage value associated with the user based on the API request information and the configuration information;
identify a billing service from a plurality of billing services associated with the user;
format the at least one usage value based on the billing service; and
communicate the at least one formatted usage value to the billing service.

10. The computing apparatus of claim 9, wherein the configuration information comprises one or more conditional statements that trigger an increase to a usage value of the at least one usage value when one or more criteria are satisfied.

11. The computing apparatus of claim 9, wherein the API request information comprises an identifier for each DNS request of the API requests.

12. The computing apparatus of claim 11, wherein the API request information further comprises a success indication associated with each DNS request of the API requests, or a data size associated with a response to each API request of the API requests.

13. The computing apparatus of claim 9, wherein formatting the at least one usage value based on the billing service comprises formatting the at least one usage value into a file format associated with the billing service.

14. The computing apparatus of claim 9, wherein the program instructions further direct the computing apparatus to:
determine whether the at least one usage value for the user satisfies one or more criteria to suggest a modification to the configuration information; and
generate a notification for the user indicating the modification.

15. The computing apparatus of claim 14, wherein the notification indicates one or more conditional statement modifications to the configuration information and one or more potential value changes to the at least one usage value from the one or more conditional statement modifications.

16. The computing apparatus of claim 9, wherein the at least one usage value comprises a monetary value.

17. An apparatus comprising:
a storage system;
program instructions stored on the storage system that, when executed by a processing system, direct the processing system to:
obtain configuration information for generating usage values associated with application programming interface (API) requests to an API provider by a user, wherein the configuration information comprises one or more conditional statements that trigger an increase to a usage value of the at least one usage value when one or more criteria are satisfied;
obtain API request information associated with API requests by the user to the API provider;
determine at least one usage value associated with the user based on the API request information and the configuration information;
identify a billing service from a plurality of billing services associated with the user;
format the at least one usage value based on the billing service; and
communicate the at least one formatted usage value to the billing service.

18. The apparatus of claim 17, wherein the API request information comprises an identifier for each DNS request of the API requests.

19. The apparatus of claim 17, wherein the API request information further comprises a success indication associated with each DNS request of the API requests, or a data size associated with a response to each API request of the API requests.

20. The apparatus of claim 17,
Wherein the API request information represents a sample set of the API requests to the API provider by the user;
wherein the program instructions further direct the processing system to determine a scale factor associated with the API request information; and
wherein determining the at least one usage value associated with the user based on the API request information and the configuration information is further based on the scale factor associated with the API request information.
